(19) United States
(12) Patent Application Publication
(10) Pub. No.: US 2011/0263163 A1
(43) Pub. Date: Oct. 27, 2011

(54) Compact Multi-Contact Plug and Socket

(76) Inventor: John Schmidli, Victoria (AU)

(21) Appl. No.: 13/130,063

(22) PCT Filed: Nov. 24, 2009
(86) PCT No.: PCT/AU09/01529

§ 371 Date: Jul. 7, 2011

(30) Foreign Application Priority Data
Nov. 26, 2008 (AU) 2008906137

(51) Int. Cl. H01R 13/24; H01R 24/00; H01R 13/02

(52) U.S. Cl. 439/700; 439/884; 439/626; 439/660

(57) ABSTRACT

An electrical connector has a plug (8.08.070) and a socket (9.002). The plug has a plurality of adjacent plug contacts (8.052, 8.054), the contact sections of the plug contacts being staggered axially. The socket (9.002) has the socket contacts (12.064) staggered axially to facilitate a compact transverse dimension of the connector.

### FIELD OF THE INVENTION

This invention relates to compact electrical and connectors.

The invention is particularly suited for multi-contact plugs and sockets. For example, the invention can be applied to a lighting system to deliver power, control, and sensing information.

### BACKGROUND OF THE INVENTION

There is a growing need to provide additional circuits in the electrical power circuits in buildings and in other applications. For example, a number of lighting circuits can be used to segment the lighting in parts of a building. In some applications, power and data cables can be provided in a single cable. Preferably these circuits should be provided using the minimum number of cables. Thus, there is a need for multi-circuit cables.

It is desirable that connectors for such cables be of a compact size.

### SUMMARY OF THE INVENTION

According to an embodiment of the invention, there is provided a plug and socket or connector arrangement for use with multi-wire cables, wherein the locations of adjacent contact points are alternately staggered.

This enables the compression of the cross-section of the connector components.

### BRIEF DESCRIPTION OF THE DRAWINGS

An embodiment or embodiments of the present invention will now be described, by way of example only, with reference to the accompanying drawings, in which:

FIG. 1 is a schematic isometric illustration of a socket according to an embodiment of the invention.

FIG. 2 is a schematic partial plan view of the contact arrangement of a socket according to an embodiment of the invention.

FIG. 3 is a schematic front illustration of a contact spring suitable for use in an embodiment of the invention.

FIG. 4 is a schematic side illustration of a contact spring suitable for use in an embodiment of the invention.

FIG. 5 is a schematic illustration of the contact spring of FIGS. 3 & 4.

FIG. 6 is a schematic side illustration of a plug contact blade suitable for use in an embodiment of the invention.

FIG. 7 a schematic exploded partial view of the contact arrangement of a socket according to an embodiment of the invention.

FIG. 8 is a schematic plan illustration of the contact layout of a plug according to an embodiment of the invention.

FIG. 9 shows a photograph of socket according to an embodiment of the invention;

FIG. 10 shows a view of the socket of FIG. 9 with the lid removed.

FIG. 11 shows a view of the inside of the lid of the socket of FIG. 9.

FIG. 12 shows detail of the stagger of the spring contacts of the socket of FIG. 9.

FIG. 13 is a view of a plug according to an embodiment of the invention.

FIG. 14 is a view illustrating the plug contacts of the plug of FIG. 13.

FIG. 15 is a top view of the plug of FIG. 13.

The numbering convention used in the drawings is that the digits in front of the full stop indicate the drawing number, and the digits after the full stop are the element reference numbers. Where possible, the same element reference number is used in different drawings to indicate corresponding elements.

### DETAILED DESCRIPTION OF THE EMBODIMENT OR EMBODIMENTS

The invention will be described with reference to the embodiments illustrated in the drawings.

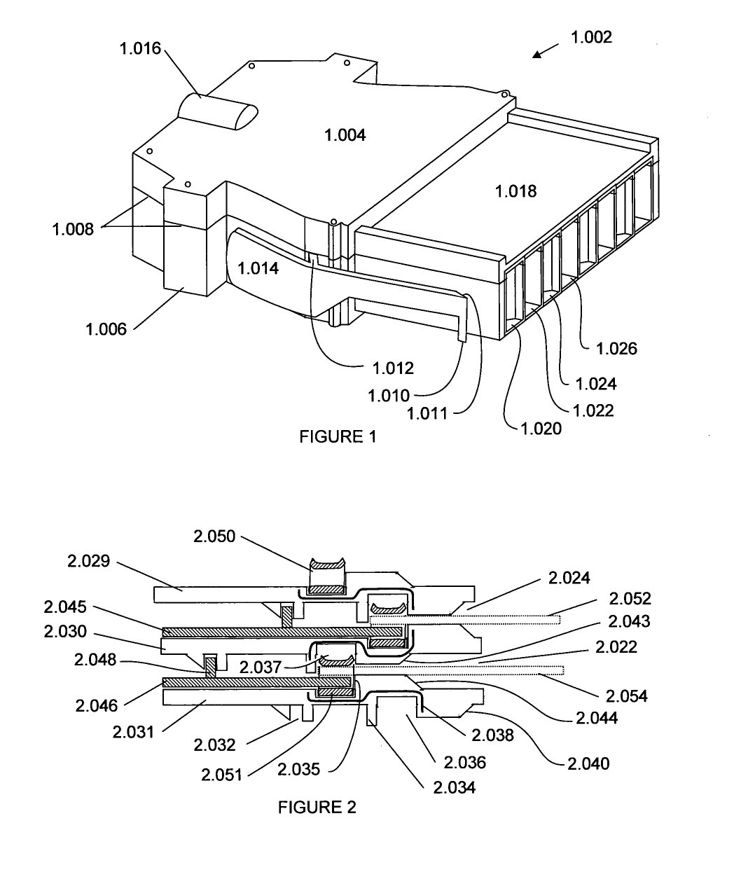

FIG. 1 schematically illustrates a socket 1.002 according to an embodiment of the invention. The socket includes a lid 1.004 and a body 1.006 which meet at junction line 1.008. A plurality of contact recesses such as 1.020, 1.022, 1,024, 1.026 through which mating plug contact blades can be inserted to make contact with socket contact blades via contact springs, as will be described below. A securing latch 1.010 which is resiliently hinged via hinge 1.012 to the body 1.006. The latch has a chamfered face 1.011 to facilitate engagement with a cooperating plug latch. A release leaver 1.014 is integrally connected to the latch 1.010.

As will be described below, each aperture 1.020, 1.022, etc., provides access to mutually isolated contact chambers containing a contact spring in conductive cooperation with a corresponding socket contact blade.

FIG. 2 is a schematic illustration of the contact supports 2.029, 2.030, 2.031, for a long socket contact blade 2.045 and a short socket contact blade 2.046. The contact supports are moulded into the base and are profiled to provide tapered entrances, plug contact blade guides, and socket contact blade supports. Pairs of adjacent contact supports, such as 2.030 and 2.031 define a contact chamber in which a socket contact blade 2.046 and a contact spring are retained, and into which a plug contact blade 2.054 can be inserted. The short socket contact blade 2.046 is adapted to connect with a corresponding long plug contact blade 2.054 which is inserted through long plug blade aperture 2.022.

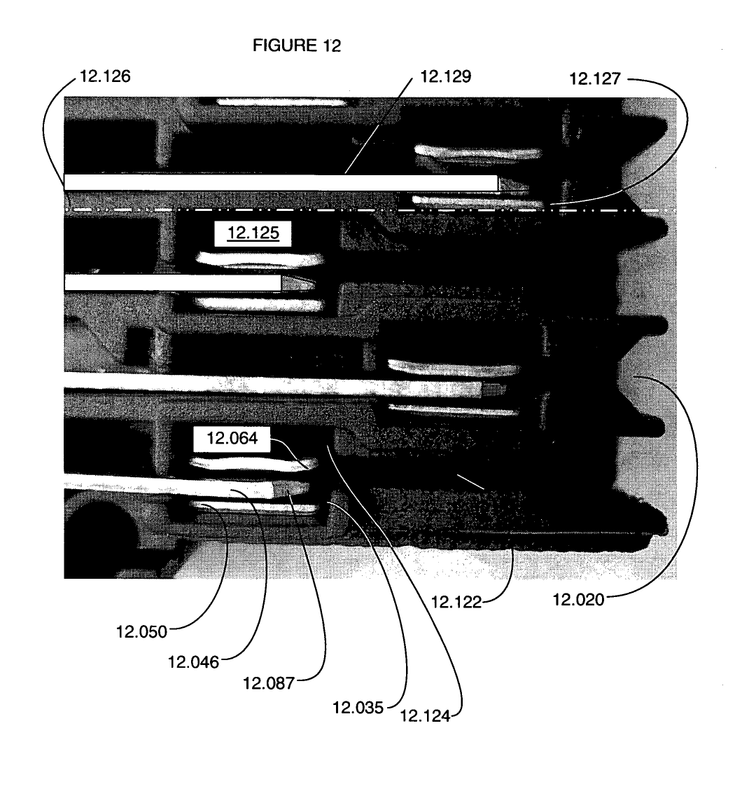

The aperture 2.022 contains a pair of tapered side walls 2.043, 2.044 to direct the incoming plug contact blade into engagement with the spring contact via a plug blade guide having parallel sides (see 12.122 in FIG. 12). The contact spring is retained in contact spring recesses 2.035, in a first of the contact supports 2.031, while an aligned contact arm displacement aperture 2.037 is located in the adjacent contact support 2.030 to permit movement of the contact spring arm when a plug contact blade 2.054 is inserted.

As can be seen in FIGS. 2, 10, and 12, the contact spring apertures such as 2.035 are staggered axially, and this staggering of the locations of the contact springs enables the arrangement of a plurality of contact springs in a more compact cross section than is possible if the contact springs were aligned transversely to the axial direction. The contact springs such as 2.051 are located in a contact spring recess 2.035 in support 2.030, and a corresponding recess 2.037 is provided in support 2.031 to permit movement of the spring contact arm when a plug connector blade such as 2.054 is inserted into the contact spring. The socket contact blades can be a loose fit in the contact spring or can be lightly resiliently contacted by the contact spring when on plug is connected. When a plug contact blade is inserted, the arm of the contact are pushed apart and the plug contact blade and the socket contact blade are held in firm electrical contact by the compression of the contact spring. Using flat contact blades for the plug and socket, as distinct from round section contacts, also assists in reducing the transverse dimension of the plug and socket.

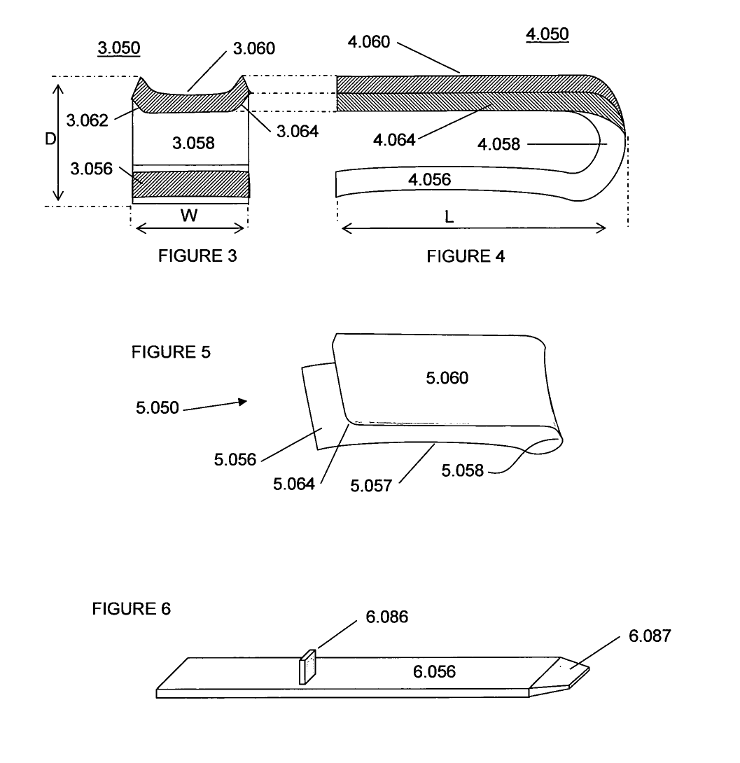

The leading end (see 6.087 in FIG. 6) of the plug contact blade 2.054 is adapted to cooperate with the curved edge 3.064 (FIG. 3) of the contact spring to permit mutual contact between the plug contact blade, the socket contact blade and the socket contact spring as described below. The leading edge of the contact blade can be tapered as shown at 6.087 to facilitate the displacement of the contact spring arm when the plug contact blade is inserted into the socket. The contact blade guide 12.122 (FIG. 12) ensures good alignment between the leading edge of the plug contact blade and the curved edge of the mating side of the spring contact. As can be seen by the dash-double dot line 12.126 in FIG. 12, staggering the contacts axially enables compression of the transverse dimension, and, in the embodiment shown, the base of the contact containing recess 12.127 on contact support 12.129 can be on the same axial line as the base of the contact arm movement recess 12.125 on the same contact support 12.129. It is also possible for the bases of the two recesses to overlap to some extent in the transverse direction. The stagger permits sufficient insulation between the adjacent contacts. In addition, the staggering of the cable ends of the contacts allows additional width for the cable connexions as these connexions are distributed over two different transverse positions.

Similarly, long socket contact 2.045 is adapted to connect with short plug contact blade 2.052 through short plug contact blade aperture 2.024. Each socket contact blade has its distal end located in a contact spring such as 2.050. Each socket contact blade has a key projection such as 2.048 adapted to engage a corresponding keyway such as 2.032 to locate the contact blade in the correct position. In this embodiment, the keyways for the long and short socket contacts are staggered axially, ie, in the insertion direction. Similarly, the contact springs for the long socket such as 2.045, and the contact springs for the short socket contact blades 2.046 are staggered axially.

FIG. 3 is a schematic illustration of the front view of a contact spring 3.050. The spring has an upper arm 3060 and an arcuate lower arm 3.056 joined at their bases by curved segment 3.058. The sides 3.062, 3.064 of the upper arm 3.060 are turned up to provide guide surfaces to cause the upper arm to deflect outwards (upwards) when a plug contact blade is inserted. FIG. 4 is a side view of the contact of FIG. 3, showing the turned up edge 4.064 of the upper arm 4.060, the curved base 4.058, and the arcuate lower arm 4.056. FIG. 5 schematically illustrates the contact spring 5.050 of FIG. 3, showing the upper arm 5.060 with upturned sides 5.064 5.062, arcuate lower arm 5.056 and curved base section 5.058.

As shown in FIGS. 3 & 4, the contact has a depth D, a width W, and a length L.

FIG. 6 is a schematic illustration of a plug contact blade 6.054 with locating key 6.086 and chamfered leading edge 6.087.

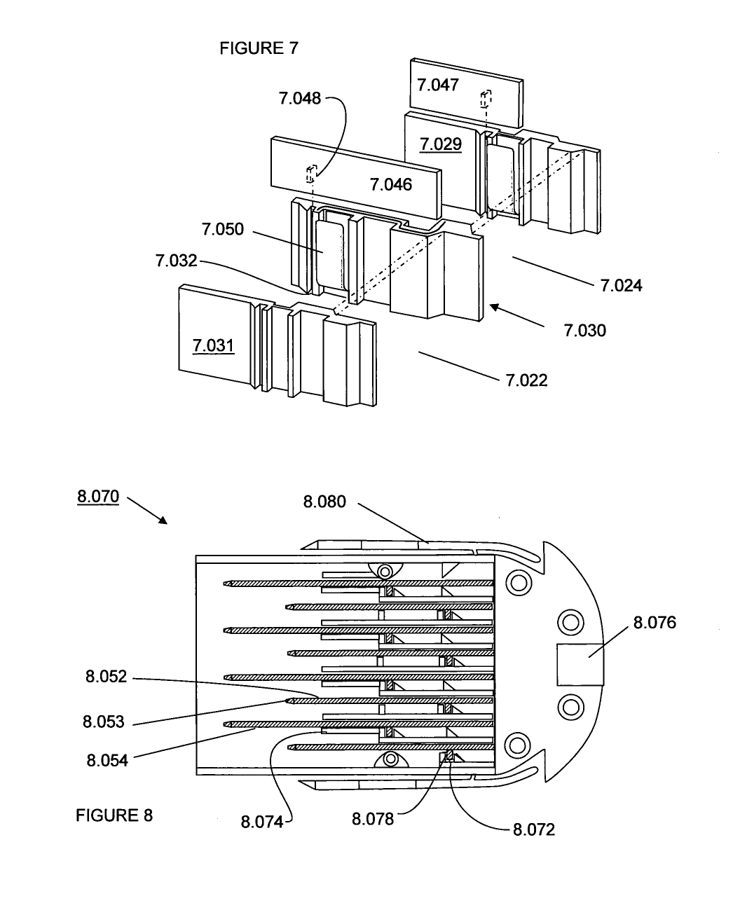

FIG. 7 is a schematic exploded partial view of the arrangement of the insulating contact supports 7.029, 7.030, 7.031 and the socket contact blades 7.046, 7.047. The contact blade key 7.048 is shown in dashed outline to indicate it is on the reverse side of the contact blade 7.046 shown in the drawing, so it can be inserted into the keyway 7.032 in the contact support 7.030 and between the arms of the contact spring 7.050.

As can be seen in FIG. 10 the intermediate contact supports include a contact recess on one side and a contact arm movement recess on the other side. The contact recesses and the contact arm movement recesses are axially staggered to facilitate reduction of the transverse dimension. The side walls of the socket housing provide either a single contact recess or contact arm movement recess for the two connector blades located at the edge of the socket contact blade array.

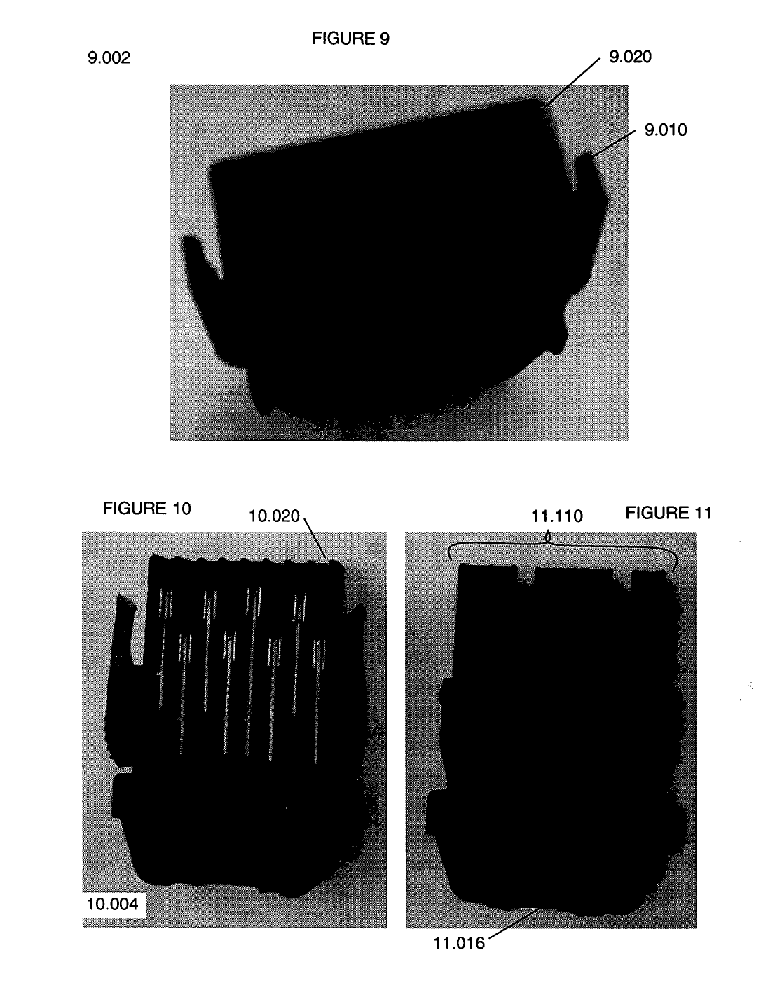

FIG. 8 illustrates schematically the plug contact blade arrangement. Long plug contact blades, such as 8.054, and short plug contact blades, such as 8.052 are arranged to cooperate with the complimentary contact blade recesses of a socket such as described with reference to FIGS. 1, 2, 7, 9, 10, 11, and 12. The tapered end of the contact blade 8.052 is illustrated at 8.053. The contact blades have projecting keys similar to the key illustrated at 6.048 in FIG. 6, and there are corresponding keyways in the plug contact blade supports moulded into the base of the plug housing in a similar manner to the keyways of the socket. To provide stability for the long plug contact blades, the contact supports are extended as illustrated at 8.074.

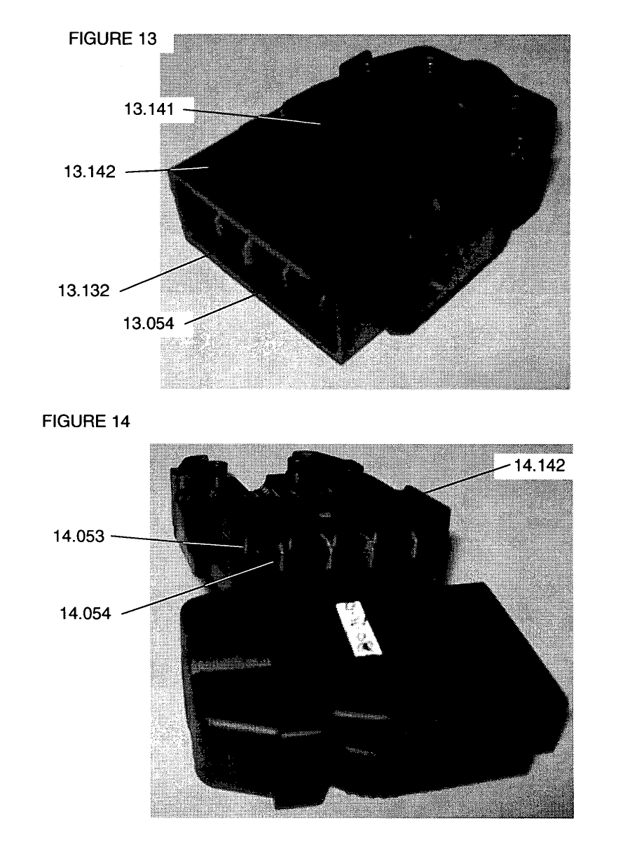

FIG. 13 illustrates a plug according to an embodiment of the invention. The long contact blades such as 13.054 are shown in the plug aperture 13.132. The plug housing has a removable partial lid 13.141, and a fixed cowling 13.142 at the insertion end of the plug. FIG. 14 illustrates the plug with the partial lid removed. The short plug contact blades such as 14.053 can be seen in this view.

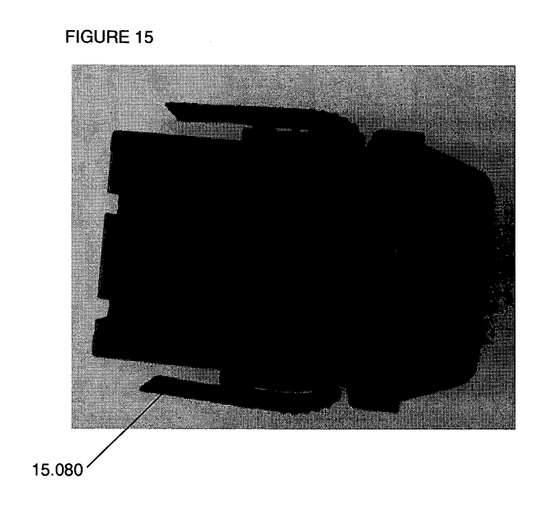

FIG. 15 is a top view of a plug according to an embodiment of the invention, illustrating the spring latch elements 15.080 adapted to cooperate with the spring latch elements 1.010 of the socket.

In an alternative arrangement of the plug, the leading edges of the plug contact blades can be aligned, and the socket recesses adapted to receive the longer blades in the “short” plug contact blade reception recesses.

In this specification, reference to a document, disclosure, or other publication or use is not an admission that the document, disclosure, publication or use forms part of the common general knowledge of the skilled worker in the field of this invention at the priority date of this specification, unless otherwise stated.

In this specification, terms indicating orientation or direction, such as “up”, “down”, “vertical”, “horizontal”, “left”, “right” “upright”, “transverse” etc. are not intended to be absolute terms unless the context requires or indicates otherwise.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. An electrical connector having a plurality of adjacent contacts, the contact sections of the contacts being staggered axially to facilitate a compact transverse dimension of the connector.

2. An electrical connector as claimed in claim 1, wherein the contact blades are flat.

3. An electrical connector as claimed in claim 1, wherein the connector includes a housing having a plurality of substantially parallel contact supports, at least some of the contact supports having a first contact recess on one side and a second contact arm movement recess on the opposite side, the first contact recess and the second contact arm movement recess being axially staggered.

4. An electrical connector as claimed in claim 3, wherein the base of the first contact recess and the base of the second contact arm movement recess are aligned on or overlap an axially aligned axis.

5. An electrical socket as claimed in claim 1, the socket including a plurality of contact springs corresponding to and cooperatively associated with the contacts, wherein the contact springs are axially staggered to facilitate a compact transverse dimension of the connector.

6. An electrical socket as claimed in claim 5, wherein each contact spring is a substantially U shaped spring, having at least one side of one arm of the U turned to provide a caroming face for engaging a mating plug contact blade.

7. An electrical socket as claimed in claim 1, including a tapered channel to receive a mating plug contact blade.

8. An electrical socket as claimed in claim 7, wherein the tapered channel merges with a contact guide having parallel sides to direct the plug contact blade into engagement with the contact spring.

9. A plug comprising an electrical connector having a plurality of adjacent contacts, the contact sections of the contacts being staggered axially to facilitate a compact transverse dimension of the connector, and having long and short plug contact blades the distal ends of which are axially staggered.

10. A plug as claimed in claim 9 having a blade arrangement adapted to connect with a socket.

11. (canceled)

12. (canceled)
